(19) United States
(12) Patent Application Publication
(10) Pub. No.: US 2025/0296740 A1
(43) Pub. Date: Sep. 25, 2025

(54) ENVELOPE AND RELEASE COVER FORMED FROM COMMON SUBSTRATE

(71) Applicant: Pregis LLC, Chicago, IL (US)

(72) Inventors: Jeffrey Menolascino, Marengo, IL (US); Daniel Leidig, Marengo, IL (US); John Bankson, Highland Park, IL (US)

(21) Appl. No.: 19/087,367

(22) Filed: Mar. 21, 2025

Related U.S. Application Data
(60) Provisional application No. 63/569,051, filed on Mar. 22, 2024.

(51) Int. Cl. B65D 27/18; B31B 70/62; B31B 160/20; B65D 27/34

(52) U.S. Cl. CPC B65D 27/18; B31B 70/62; B65D 27/34; B31B 2160/20

(57) ABSTRACT

Envelopes include a cover for covering and isolating a closure sealing element on the envelope before the envelope is loaded and sealed. The cover can be formed as part of an adjacent wall of the envelope, and can be separated from the wall by a cut or a line or weakness between the cover and the wall.

### CROSS-REFERENCE TO RELATED APPLICATIONS

This application claims the benefit under 35 U.S.C. § 119(e) of U.S. Provisional Patent Application No. 63/569,051, filed Mar. 22, 2024, the contents of which are incorporated by reference herein in their entirety.

### BACKGROUND

Envelopes are in widespread use to ship small and medium-sized items in e-commerce and other applications. Most shipping envelopes have some provision to form a closure seal to maintain the envelope in a closed state after the item to be shipped has been loaded therein. For example, the envelope may have a pressure-sensitive adhesive applied to a closure flap or other portion thereof. Once the item to be shipped has been placed inside the envelope through an opening in the top of the envelope, the closure flap is rotated to a closed position to cover the opening. Rotating the closure flap brings the pressure-sensitive adhesive into contact with an outer surface of the envelope so that the pressure-sensitive adhesive bonds with the outer surface and forms a closure seal that maintains the closure flap in its closed position.

The pressure-sensitive adhesive needs to remain covered until the envelope is to be closed and sealed, to prevent the adhesive from bonding unintentionally to the adjacent surface of the envelope. To prevent such unintentional bonding, the adhesive typically is covered by a release strip having properties that cause the release strip to adhere lightly to the adhesive so that the release strip will remain in place, but can be removed by the user without removing or otherwise damaging the underlying adhesive. Providing a release strip, however, adds a step to the envelope manufacturing process and requires the production or procurement of an additional part for the envelope.

### SUMMARY

In one aspect of the disclosed technology, an envelope for holding an item includes a first wall, and a second wall overlying the first wall. The first and second walls define a pocket located between the first and second walls, the pocket configured and dimensioned to contain the item. The first and second walls also define a pocket opening allowing access to the pocket from an exterior of the envelope for loading the item into the pocket.

The envelope further includes a closure flap hingedly connected to the first wall to rotate between an open position, allowing access to the pocket through the pocket opening, and a closed position in which the closure flap extends from the first wall, across the pocket opening on onto the second wall to attach thereto, thereby closing the pocket opening.

The envelope further includes a bonding element disposed on the closure flap and configured to seal to the second wall when the closure flap is in the closed position, and a cover overlying the bonding element. The cover includes a substrate formed from the same material as the second wall, and a release layer disposed on the substrate. The release layer is configured to bond sufficiently to the bonding element so that the cover is releasably attached to the closure flap.

In another aspect of the disclosed technology, the release layer extends to an upper edge of the substrate.

In another aspect of the disclosed technology, the release layer covers an entirety of one side of the substrate.

In another aspect of the disclosed technology, a perimeter of the cover matches a perimeter of the closure flap.

In another aspect of the disclosed technology, the envelope further includes a separation region between the cover and the second wall.

In another aspect of the disclosed technology, the separation region includes a cut separating the cover from the second wall.

In another aspect of the disclosed technology, the cut is a kiss cut.

In another aspect of the disclosed technology, the separation region includes a line of weakness sufficient to propagate a tear along the line of weakness.

In another aspect of the disclosed technology, the line of weakness includes perforations and/or a score line.

In another aspect of the disclosed technology, the bonding element has sufficient tackiness to adhere to the release layer to retain the cover on the closure flap.

In another aspect of the disclosed technology, the bonding element is a hot-melt adhesive.

In another aspect of the disclosed technology, the closure flap is further configured to close the pocket opening.

In another aspect of the disclosed technology, the bonding element is configured to form the closure seal upon the application of pressure to the bonding element.

In another aspect of the disclosed technology, the first wall and/or second wall is made of paper.

In another aspect of the disclosed technology, the envelope further includes a gusset connected to the first and second walls.

In another aspect of the disclosed technology, the envelope further includes an attachment lip extending from the gusset and fixed to an exterior side of the envelope.

In another aspect of the disclosed technology, the closure flap includes side edges tapered in relation to a longitudinal direction of the envelope, and the cover includes side edges having a taper that approximately matches a taper of the side edges of the closure flap.

In another aspect of the disclosed technology, the second wall and the substrate are cut from a single piece of web material.

In another aspect of the disclosed technology, the cover includes a first portion configured to overlie a first portion of the bonding element when the closure flap is in the first position, and a second portion configured to overlie a second portion of the bonding element when the closure flap is in the first position. The second portion of the cover is configured to be removed from the second portion of the bonding element while the first portion of the cover overlies the first portion of the bonding element.

In another aspect of the disclosed technology, the first and second walls are flexible.

In another aspect of the disclosed technology, the first wall and/or the second flexible wall include at least two overlying layers affixed to each other about an interlayer border that encloses a plurality of sides of an interlayer region defined by the at least two overlying layers.

In another aspect of the disclosed technology, a method of manufacturing an envelope includes providing a first web of material and a second web of material, applying a first bonding element on the first and/or the second web, applying a release layer on the second web, and applying a second bonding element on the first and/or the second web.

The method further includes overlaying the second web on the first web, joining the first web to the second web, and creating a separation region through the second web adjacent to the release layer to define a cover comprising the release layer and an overlying portion of the second web, the separation region allowing the cover to be peeled off and separated from second wall.

In another aspect of the disclosed technology, joining the first web to the second web includes bringing the first web into contact with the second web so that the first bonding element forms side and transverse seals between the first and second webs, and the second bonding element opposes the release layer.

In another aspect of the disclosed technology, the method further includes applying heat or pressure to form the side and transverse seals between the first and second webs.

In another aspect of the disclosed technology, creating a separation region through the second wall adjacent to the release layer includes forming at least one or more of a kiss cut and lines of weakness in the second web.

In another aspect of the disclosed technology, the method further includes removably adhering the cover to the first wall via the second bonding element and the release layer.

In another aspect of the disclosed technology, the release layer configured to bond sufficiently to the bonding element so that the cover is releasably attached to the closure flap.

In another aspect of the disclosed technology, the method further includes forming a fold line in the first web adjacent the separation region.

In another aspect of the disclosed technology, the second bonding element is pressure-sensitive adhesive.

In another aspect of the disclosed technology, the first web and/or the second web is made of paper.

### BRIEF DESCRIPTION OF DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a perspective view of an envelope having a cover configured to cover a closure flap of the envelope, depicting the cover spaced from the closure flap for illustrative clarity;

FIG. 2 is a side view of the envelope shown in FIG. 1, depicting the cover spaced from the closure flap;

FIG. 3 is a cross-sectional view of the envelope shown in FIGS. 1 and 2;

FIG. 4 is a perspective view of a web of the envelopes shown in FIGS. 1-3;

FIG. 5 is a perspective view the envelope shown in FIGS. 1-3, with the cover of the envelope removed to facilitate closing and sealing of the envelope;

FIG. 6 is a perspective view of the envelope shown in FIGS. 1-5, depicting the envelope in a closed and sealed condition and holding an item;

FIG. 7 is a cross-sectional view of the envelope shown in FIGS. 1-6, taken through the line VII-VII of FIG. 6; and

FIG. 8 is a front view of an alternative embodiment of the envelope shown in FIGS. 1-6, depicting a closure flap of the envelope in an open position;

FIG. 9 is a front view of the envelope shown in FIG. 8, depicting an upper portion of a cover of the envelope being removed with the closure flap in the open position;

FIG. 10 is a front view of the envelope shown in FIGS. 8 and 9, depicting the closure flap in a closed position, and depicting the envelope in a closed and sealed condition and holding an item;

FIG. 11 is a front view of the envelope shown in FIGS. 8-10, depicting a tear strip on the closure flap being removed with the closure flap in the closed position;

FIG. 12 is a front view of the envelope shown in FIGS. 8-11, depicting a lower portion of the cover being removed with a lower portion of the closure flap in an open position;

FIG. 13 is a front view of the envelope shown in FIGS. 8-12, depicting the lower portion of the closure flap in a closed position and depicting the envelope in a closed and sealed condition and holding another item; and

FIG. 14 is a front view of an alternative embodiment of the envelope shown in FIGS. 8-13.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

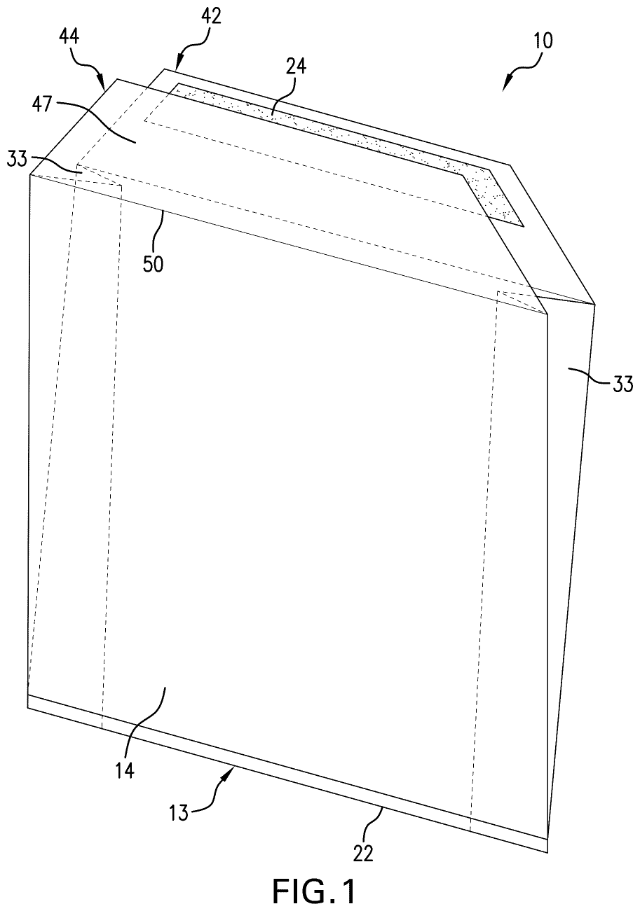

Directional terms such as “top,” “bottom,” “upper,” “lower,” etc. are used in relation to the component orientations depicted in FIG. 1. These terms are used for illustrative purposes only and are not intended to limit the scope of the appended claims.

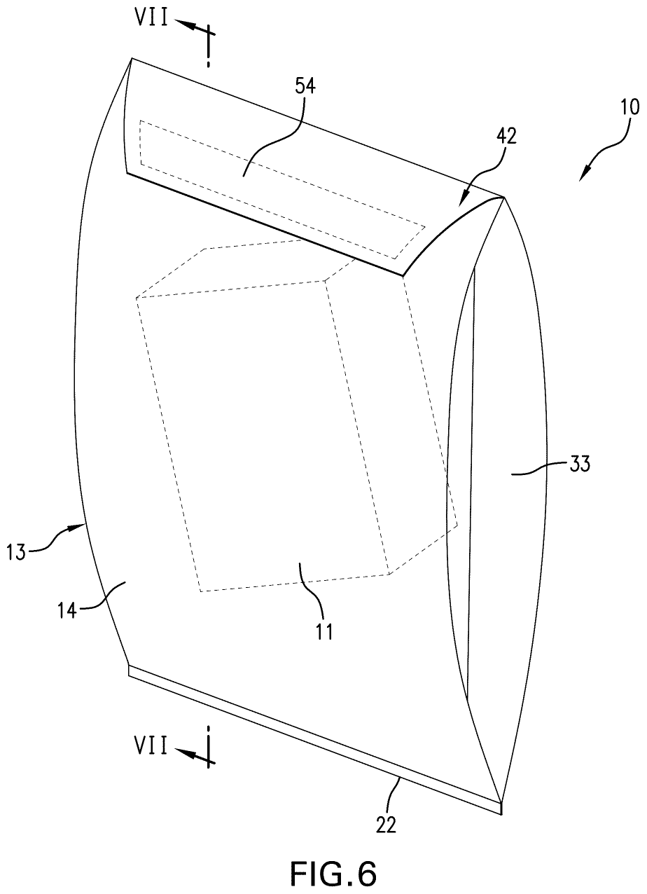

FIGS. 1-3 and 5-8 depict an envelope 10. The envelope 10 is configured to contain and hold an item 11 to be packaged. The envelope 10 typically encloses the item 11 while the item 11 is being mailed, shipped, or otherwise needs to be packaged in a closed container. The item 11 is depicted in phantom in FIG. 6.

Packaging articles include, for example, packaging containers, protective packaging articles, and thermal insulation articles. Packaging containers can include parcel packaging and other containers to package items. Packaging containers are configured to contain and hold an item, typically enclosing the item, during shipping or storage of the item. Parcel packaging is configured for shipping and/or storing products, such as for storage in warehouse or retail shelves and displays. Examples of parcel packaging include flexible shipping containers such as envelopes, which can have varying degrees of flexibility and typically are used to ship or mail small or relatively flat items or smaller items around which the walls of the container can conform envelopes. Flexible shipping containers such as envelopes can be padded or non-padded, can be made of materials such as paper and flexible cardboard, can be configured with or without sidewalls or gussets, and can include larger envelopes such as mailers. Examples of parcel packaging also include bags, such as paper or poly bags, which can have a self-sealing capability and are typically used to ship small to medium-sized items; boxes, which can be formed from paperboard, cardboard, wood, or plastic, and typically have a rigid or semi-rigid structure suitable for holding medium to large-size items and heavier items; and shipping tubes or tube mailers, typically used to ship documents and paper items.

The term “envelope,” as used herein, is intended to encompass, without being limited to, flat shipping containers, including mailers, typically used to ship or mail smaller items and having sufficient flexibility so as to expand and bend around the item 11 upon insertion of the item 11 into a pocket within the envelope 10; and in which the sidewalls or thickness of the container are substantially smaller than, e.g., less than 1/100th (one percent) of, the width and/or height of the container.

The envelope 10 comprises an envelope body 13 that includes a wall 12, an opposing wall 14, and two side gussets 33. Each side gusset 33 in connected to the wall 12 and the wall 14, as can be seen in FIG. 3. The wall 12 is visible in FIGS. 3, 5, and 7.

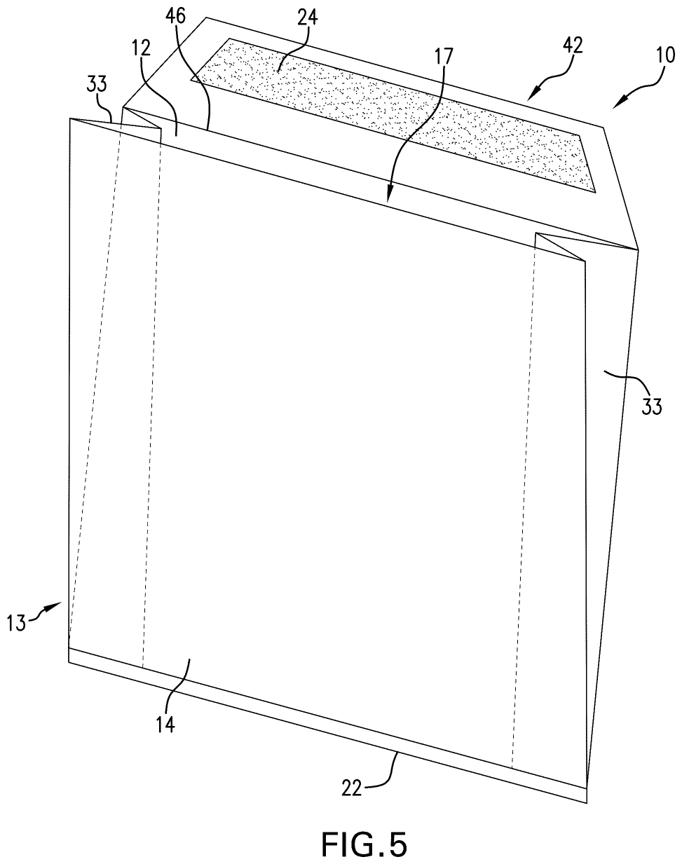

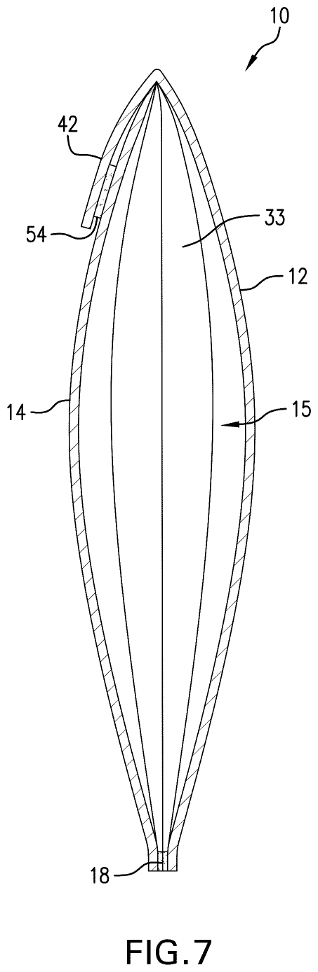

Each side gusset 33 facilitates expansion of the envelope body 13 by permitting the walls 12, 14 to move away from each other. The walls 12, 14 and the gussets 33 define an internal containment area or envelope pocket 15 that receives the item 11 being held within the envelope 10. The envelope pocket 15 is accessible by way of an opening 17 defined by the walls 12, 14 and the gussets 33 at the top of the envelope body 13. The opening 17 is denoted in FIG. 5. The envelope pocket 15 is visible in FIGS. 3 and 7.

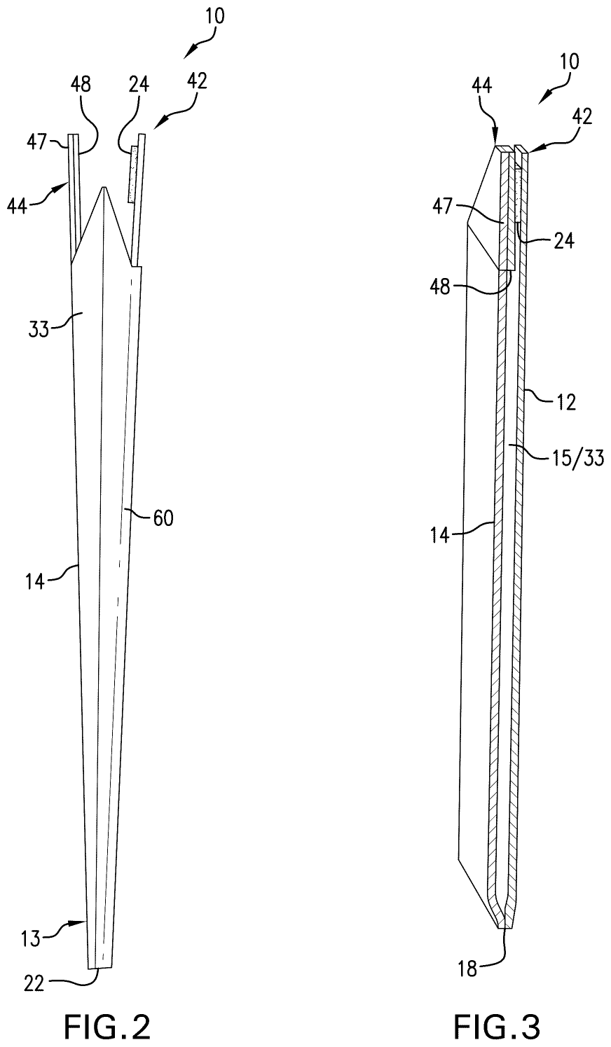

The envelope 10 also includes a closure flap 42. The closure flap 42 is unitarily formed with the wall 12 and adjoins an upper edge of the wall 12 as can be seen in FIGS. 2 and 5. A score line 46 is formed at the interface of the closure flap 42 and the wall 12. The score line 46, visible in FIG. 5, causes the underlying portion of the envelope material to act as a living hinge that allows the closure flap 42 to rotate between an open position shown in FIGS. 1-3 and 5, and a closed position shown in FIGS. 6 and 7.

When in the open position, the closure flap 42 allows the envelope pocket 15 to be accessed via the opening 17 between the walls 12, 14, so that the packaged item 11 can be inserted into the envelope pocket 15. When in the closed position, the closure flap 42 covers the opening 17 and thereby maintains the opening 17 in a closed state, so that the packaged item 11 is retained within the envelope 10.

A bonding element in the form of a closure sealing element 24 is disposed on the closure flap 42, as shown in FIGS. 1-3 and 5. The closure sealing element 24 is configured to bond to the outwardly facing surface of the wall 14 when the closure flap 42 is in its closed position, thereby fixing the closure flap 42 in the closed position and maintaining the opening 17 in its closed state.

The closure sealing element 24 can be, for example, a pressure-sensitive hot-melt adhesive with sufficient tackiness at room temperature to form a bond that fixes the closure flap 42 to the wall 14 of the envelope 10 as discussed below.

Hot-melt adhesives are thermoplastic polymers that are solid at room temperature, become molten when heated to a temperature above their softening point, and resolidify by loss of heat, increasing in strength as they resolidify. Most hot-melt adhesives, upon melting into a molten state and re-solidifying, do not undergo any chemical reaction such as cross-linking or removal of a carrier, e.g., evaporation of water. Thus, hot-melt adhesives typically can be re-activated, i.e., re-melted and re-solidified, after initially being applied to a substrate.

Some hot-melt adhesives can have minimal, or no tackiness when in their solid form, so that the hot-melt adhesive, after initially being applied to a substrate and cooling, does not bond or otherwise adhere to another substrate or object, or to the skin of a user contacting the hot-melt adhesive. In applications in which some degree of tackiness at room temperature or other temperature ranges is desired, tackifiers or tackifying agents can be added to the hot-melt adhesive in an amount sufficient to achieve the desired level of tackiness.

The hot-melt adhesive of the closure-sealing element 24, upon melting into a molten state and re-solidifying, does not undergo any chemical reaction such as cross-linking or removal of a carrier, e.g., evaporation of water. Thus, the hot-melt adhesive can be re-activated, i.e., heated to re-melt, followed by re-solidification, after initially being applied to the closure flap 42 or other substrate.

Other types of bonding elements can be used as the closure sealing element 24 in alternative embodiments. For example, the closure sealing element 24 can be a cold adhesive in alternative embodiments. In other alternative embodiments, for example, the closure sealing element 24 can be a heat-seal material. In the case of paper substrates to be fixed to each other, a heat-seal material may be applied to each of the substrates. At the time the substrates are to be fixed, the heat-seal material on one or both of the substrates is subject to heat and pressure sufficient to weld the heat-seal materials together, thereby fixing the paper substrates to each other.

Referring to FIGS. 1-3, the envelope 10 also includes a cover 44. The cover 44 covers the closure flap 42 before the closure flap 42 is closed and sealed as can be seen in FIG. 3. The cover 44 comprises a substrate 47, and a release layer 48 the coves an entirely of one side of the substrate 47. In alternative embodiments, the release layer 48 can cover less than an entirety of the surface of the substrate 48. The release layer 48 is configured to lightly adhere to the closure sealing element 24 on the closure flap 42, so that the cover 44 will be retained on the closure flap 42 until the user removes the cover 44. In particular, the release layer 48 is configured so that adhesion between the release layer 48 and the closure sealing element 24 is sufficient to prevent the cover 44 from falling off of, or easily separating from the closure flap 42, but low enough to allow the cover 44 to be pulled or otherwise separated from the closure flap 42 without removing, tearing, or otherwise damaging the closure sealing element 24, the closure flap 42, or any other part of the envelope 10.

The cover 44 has a shape and dimensions that approximately match the shape and dimensions of the closure flap 42. The cover 44 can have a shape and dimensions that do not match those of the closure flap 42 in alternative embodiments.

In some embodiments, the release layer 48 can be, for example, a silicone material. In other embodiments, the release layer 48 can be, for example, a UV curable release material. In other embodiments, the release layer 48 can be, for example, a UV-curable cationic release silicone. In other embodiments, the release layer 48 can be, for example, a UV curable silicon release material such as Elkeem UV POLY 206. The release layer 48 can be formed from other materials and other compositions in other alternative embodiments.

The release layer 48 can cover the entire inwardly facing surface of the cover 44. In alternative embodiments, the release layer 48 can be applied only to the portion of the cover 44 that opposes the closure sealing element 24 when the closure flap 42 is moved to its closed position. In other alternative embodiments, the release layer 48 can cover the entire surface of the web from which the wall 14 and the cover 44 are formed.

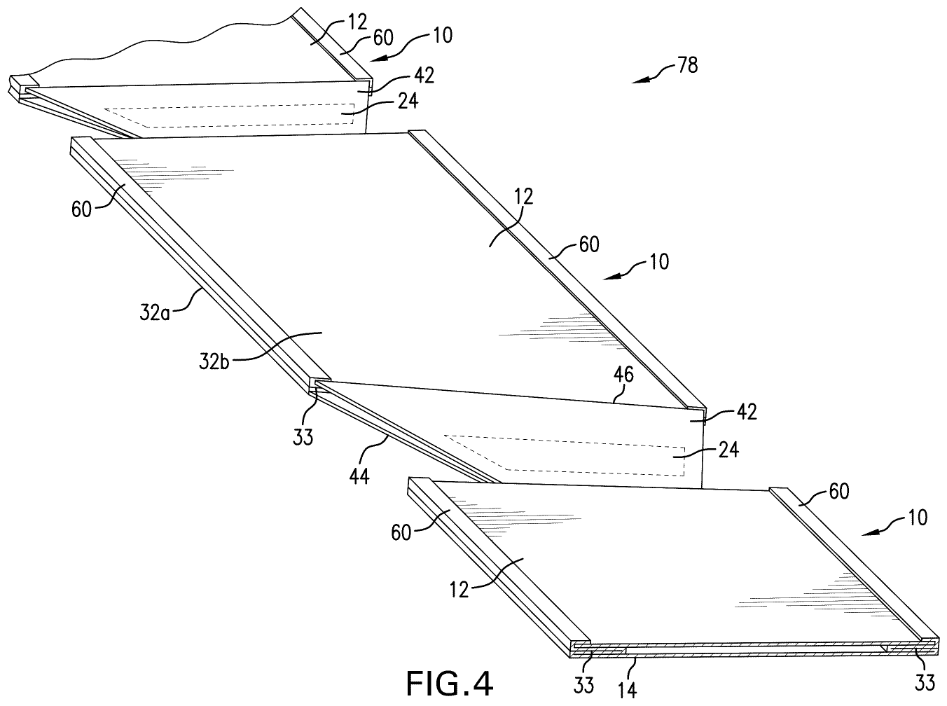

The wall 12 and the closure flap 42, and the gussets 33 can be formed from a web 32b of extensible paper, depicted in FIG. 4. The wall 14, the cover 44, and the gussets 33 can be formed from a web 32b of extensible paper, also depicted FIG. 4 in an assembled state with the web 32a. The basis weight of the paper is application-dependent and can vary with factors such as the load to which the envelope 10 will be subjected when loaded with the item 11. In some embodiments, the paper can be a single ply of 55-pound (ream weight) paper sold by Canadian Kraft Paper Industries Ltd. of Manitoba, Canada, as “SPX® extensible Kraft paper,” which has a stretch, i.e., extensibility, of about 6.8 percent in the machine direction and about 8.9 percent in the cross-machine direction; a tensile strength of about 45.7 lbs/inch in the machine direction and about 33.1 lbs/inch in the cross-machine direction; a tear strength of about 110 grams in the machine direction and about 120 grams in the cross-machine direction; and a TEA of about 19.2 ft-lb/ft² in the machine direction and about and 20.9 ft-lb/ft² in the cross-machine direction. Other types of paper can be used in the alternative. For example, the webs 32a, 32b can be formed from a single ply of 30-pound to 90-pound “SPX® extensible Kraft paper,” depending on the degree of strength of the walls 12, 14 required for a particular application. Other suitable weights can be used in other embodiments.

In alternative embodiments, one of the webs 32a, 32b can be formed from extensible paper, and the other web 32a, 32b can be formed from regular (non-extensible) kraft paper, another type of non-extensible paper, or another type of material such as polyethylene. In other alternative embodiments, both webs 32a, 32b can be formed from non-extensible paper, sack paper, or any other suitable type of paper.

In applications where the extensibility and/or the TEA of the extensible paper are greater in the machine direction than in the cross-machine direction of the paper, the webs 32a, 32b of extensible paper can be oriented so that the machine direction of the paper coincides with the direction of the envelope 10 in which greater stretch and/or TEA is needed or otherwise desired. For example, the walls 12, 14 can be configured so that the machine direction of the extensible paper coincides with the transverse direction of the envelope 10, to facilitate maximal stretching of the walls 12, 14 proximate the envelope pocket 15, as the walls 12, 14 are spread apart to facilitate insertion of the item 11 into the envelope pocket 15 as discussed below. Conversely, in applications where the stretch and/or the TEA of the extensible paper is greater in the cross-machine direction than in the machine direction of the paper, the webs 32a, 32b can be oriented so that the cross-machine direction of the paper coincides with the direction of the envelope 10 in which greater stretch and/or TEA are needed or otherwise desired.

Also, the webs 32a, 32b can be oriented so that the machine and cross-machine directions do not align with either of the longitudinal or transverse directions of the envelope 10. For example, the extensible paper of the webs 32a, 32b can be oriented so that the machine and cross-machine directions of the paper are diagonal to the longitudinal and transverse directions of the envelope 10, i.e., the extensible paper can be oriented so that the machine and cross-machine directions of the paper are offset from the longitudinal and transverse directions of the envelope 10 by about 45 degrees.

The gussets 33 can be formed by folding the web 32a multiple times at and near its longitudinal edges. For example, the web 32a can be folded using a plow folding technique in which the web 32a of paper is drawn over one or more rotary plows with edges that are inclined so that the plows force the web 32a to fold about fold lines extending in a direction parallel to the direction of movement of the web 32a. In some embodiments, brushes and creasers can be used in addition to the plows to fold the web 32a. The gussets 33 can be formed using other techniques in the alternative.

Longitudinally extending side-edge portions of the web 32a define attachment lips 60 that form side seams on the respective sides of the envelope 10. The attachment lips 60 are located outward of the portions of the web 32a that form the respective gussets 33. As discussed below, the attachment lips 60 are folded over, and onto the outwardly facing surface of the wall 12 and are fixed to the outwardly facing surface of the wall 12 to connect the wall 12 to the gussets 33 and the wall 14.

The web 32a is wider than the web 32b by an amount about equal to the combined unfolded width of the gussets 33, plus the combined width of the attachment lips 60.

The envelope 10 also includes two longitudinal seals 16, and a transverse seal 18. The longitudinal seals 16 fix the attachment lips 60 to the wall 12. The transverse seal 18 fixes the bottom of the wall 12 to the bottom of the wall 14 and is visible in FIGS. 3 and 7. The longitudinal seals 16 and the transverse seals 18 are formed from a bonding element in the form of, for example, a pressure-sensitive cold adhesive. Other types of bonding elements and other types of adhesives, such as a heat-sealable material or a hot-melt adhesive, can be used lieu of the pressure-sensitive adhesive in alternative embodiments.

The wall 12, the wall 14, the longitudinal seals 16, and the transverse seals 18 define a pocket border that encloses the envelope pocket 15. The closure flap 42 forms another portion of the pocket border when the closure flap 42 is folded to its closed position shown in FIGS. 6 and 7.

The release layer 48 is applied to the web 32a at the respective locations corresponding to the locations at which the release layer 48 will be located on the completed envelopes 10. Likewise, the closure sealing elements 24 are applied to the web 32b at the respective locations corresponding to the locations at which the closure sealing elements 24 will be located on the completed envelopes 10. Alternatively, the closure sealing elements 24 can be applied over the areas of the release layer 48 on the web 32a, and can be transferred to the web 32b when the webs 32a, 32b are joined to each other.

Also, the bonding element that forms the longitudinal and transverse seals 16, 18 is applied to the web 32a at the respective locations at which the longitudinal and transverse seals 16, 18 will be located once the webs 32a, 32b have been joined to form a web 78 of envelopes 10. And the score lines 46 are formed in the web 32b at the respective locations corresponding to the locations at which the score lines 46 will be located on the completed envelopes 10.

During assembly of the web 78, the webs 32a, 32b are aligned after the web 32a has been folded to define the gussets 33. The webs 32a, 32b are aligned so that each side edge portion of the web 32b aligns with the folded material on the web 32a that defines a respective one of the gussets 33. The webs 32a, 32b are then brought into contact with each other, and the attachment lips 60 are folded over and onto the outwardly facing surface of the web 32b so that the bonding element on the attachment lips 60 form the longitudinal seals 16 that bond the gussets 33 and the adjoining wall 14 to the wall 12 of the partially formed envelope 10. Also, the transversely extending strips of the bonding element, upon contacting the inwardly facing surface of the web 32b, form the transverse seals 18 that bond the bottom of the wall 12 to the bottom of the wall 14 of the partially formed envelope 10.

Once the webs 32a, 32b have been joined in the above manner to form the web 78 of envelopes 10, a separation region can be defined by forming a kiss cut 50 can be made through the web 32a to define the cover 44 and the wall 14 of each envelope 10, with each cover 44 comprising a respective patch of the release layer 48, and the underlying portion of the paper from which the web 32a is formed. The underlying paper thus forms a substrate on which the release layer 48 is disposed.

Each kiss cut 50 can be made in the web 32a at a location corresponding to the top of the wall 14 and the bottom of the cover 44 of the corresponding envelope 10. Because the respective heights, or lengthwise dimensions of the walls 12, 14 are about equal, the kiss cut 50 is located approximately adjacent to a respective score line 46 between the wall 12 and the closure flap 42 in the web 32b. The kiss cuts 50 are visible and FIGS. 1 and 4.

The kiss cuts 50 can extend through the underlying portions of the gussets 33. In alternative embodiments, the kiss cuts 50 can be configured not to extend through the underlying portions of the gussets 33.

Each kiss cut 50 defines the boundary between the wall 14 and the cover 44 of the corresponding envelope 10, and permits the cover 44 to be removed from the envelope 10 when the envelope 10 is to be loaded and sealed. As noted above, the release layer 48 on the cover 44 is configured to adhere to the closure sealing element 24 to prevent the cover 44 from falling off of, or easily separating from the closure flap 42, while allowing the cover 44 to be removed from the closure flap 42 without having bonded to the closure sealing element 43, and with tearing or otherwise damaging the closure flap 42 or any other part of the envelope 10. Thus, the cover 44 will remain on the envelope 10 prior to the loading and sealing of the envelope 10, e.g., during shipping of envelope 10 to the end user, thereby preventing the closure sealing element 24 on the closure flap 42 from contacting and adhering to other objects such as adjacent envelopes 10 in a stack of the envelopes 10. Also, the closure sealing element 24 should retain its ability to form a closure seal 54 that fixes the closure flap 42 to the wall 12 with sufficient strength to maintain the closure flap 42 in its closed position after the item 11 has been loaded into the envelope 10 and as the envelope 10 is being shipped and handled. The requisite strength of the closure seal 54 is application-dependent, and can vary with factors such as the size of the envelope 10 and the closure seal 54, the size and weight of the item 11, the properties of the paper or other material from which the envelope 10 is formed, etc. An appropriate closure sealing element 24 can be selected for a particular application using the knowledge generally attributed to those of ordinary skill in the field of adhesives technology.

The longitudinal seals 16, which further define the side seams formed by the attachment lips 60, extend continuously along the respective side edge portions of the envelope 10. The longitudinal seals 16 can be non-continuous in alternative embodiments.

The transverse seal 18 extends continuously along the bottom edge 22 of the envelope 10 in the transverse direction and intersects the longitudinal seals 16. The transverse seal 18 can be offset from the bottom edge 22 of the envelope 10 in alternative embodiments. Also, the transverse seal 18 can extend over a distance less than the distance between the longitudinal seals 16, and/or can be non-continuous in alternative embodiments.

In alternative embodiments of the envelope 10, the bottom portion of the inner surface of the wall 14 can be folded over and onto the bottom portion of the wall 12 to create a fold that reinforces the bottom of the envelope 10.

In alternative embodiments the envelope 10, the gussets 33 and the attachment lips 60 can be unitarily formed with the wall 12 instead of the wall 14, and can be adhered to the wall 14. In other alternative embodiments, the envelope 10 can be formed without the gussets 33. In such embodiments, the walls 12, 14 can be connected directly to each other. In other alternative embodiments, the envelope 10 can include an additional gusset 33 that extends along the bottom portion of the envelope 10, i.e., adjacent to the lower edge 22 of the envelope 10.

The attachment lips 60 can have a width of, for example, about 0.25 inch to about 1 inch. The longitudinal and transverse seals 16, 18 each can have a similar width. The seals 16, 18 can have a width above or below this range in alternative embodiments. The attachment lips 60 can have a width above or below this range in alternative embodiments.

In other alternative embodiments, the wall 12 and the closure flap 42 can be formed from two of the webs 32b affixed to each other; and the wall 14, gussets 33, and attachment lips 60 can be formed from two of the webs 32a affixed to each other. In such embodiments, the wall 12 and the wall 14 each have two layers affixed to each other about an interlayer border that encloses a plurality of sides of an interlayer region defined by the overlying layers. In some embodiments, the two overlying layers can be unadhered to each other within at least a portion of the interlayer region, and the interlayer region can be empty so that the overlying layers abut each other over a majority of the interlayer region.

The two layers of each wall 12, 14 can be affixed to each other by two longitudinal inter-layer seals and two transverse inter-layer seals formed from a bonding element in the form of an adhesive material. The longitudinal inter-layer seals can be located along longitudinal edges of the respective walls 12, 14, and extend substantially in a longitudinal direction of the walls 12, 14. Each longitudinal inter-layer seal can be offset from the corresponding edge of the wall 12 or the wall 14 in the alternative. The longitudinal inter-layer seals can be continuous. The longitudinal inter-layer seals can be non-continuous in the alternative. The transverse inter-layer seals can be located along the lower and upper edges of the walls 12, 14, and extend substantially in a transverse direction of the walls 12, 14, between the longitudinal inter-layer seals. The transverse inter-layer seals can be offset from the lower and upper edges of the wall 12 or the wall 14 in the alternative. The transverse inter-layer seals are continuous. The transverse inter-layer seals can be non-continuous in the alternative.

An angled cut and an adjoining transverse cut can be made through each envelope 10 on each side of the cover 44 to form a triangular cutout on each side the cover 44. This step removes the attachment lips 60 from the cover 44, which in turn permits the cover 44 to be separated from the closure flap 42 as discussed below. The cover 44 and the flap 42 are depicted as having similarly angled or side edges that give the cover 44 and the flap 42 a trapezoidal shape. The cover 44 and the flap 42 can have other shapes, including a rectangular shape, in alternative embodiments.

Once the web 78 of envelopes 10 has been assembled as discussed above, the individual envelopes 10 be separated from the web 78 by a suitable technique such as cutting, the focused applicant of heat, etc. In alternative embodiments, the separation region can be defined by forming a line of weakness, such as a series of perforations or a score line, can be formed between the individual envelopes 10 in the web 78 so that the envelopes 10 can be separated from the web 78 by tearing the envelopes 10 along the line of weakness.

When the envelope 10 is to be loaded and sealed, the user can remove the cover 44 by pulling the cover 44 to separate the release layer 48 on the cover 44 from the closure sealing element 24 and thereby expose the closure sealing element 24. The wall 14 then can be pulled away from the wall 12 to define the envelope pocket 15 and the opening 17 that leads thereto. The item 11 can be placed in the envelope pocket 15, and the closure flap 42 can be folded from its open position to its closed position, to bring the closure sealing element 24 into contact with the outwardly facing surface of the wall 14. Alternatively, the cover 44 can be removed after the item 11 has been loaded into the envelope pocket 15, to help avoid inadvertent contact between the item 11 and the closure sealing element 24. Once the closure flap 42 has been moved to its closed position, the user can press the closure flap 42 into the adjacent portion of the wall 12 so that the closure sealing element 24 forms the closure seal 54 that fixes the closure flap 42 to the wall 12, thereby securing the item 11 in the envelope pocket 15. The closure seal 54 is depicted in FIGS. 6 and 7. (In applications where the closure sealing element 24 requires reactivation, the closure sealing element 24 can be heated, and the closure flap 42 and the adjacent portion of the wall 14 can be pressed together to form the closure seal 54.)

In alternative embodiments, the cover 44 can remain attached to the wall 14 by way of a line of weakness, formed by perforations, scoring, or another suitable technique, that permits the cover 44 to be removed from the wall 14 without tearing or otherwise damaging the wall 14 during the loading process for the envelope 10. For example, alternative embodiments of the envelope 10 can include perforations in lieu of the kiss cut 50. In other alternative embodiments, instead of removing the cover 44, the user can fold the cover 44 inwardly and into the envelope pocket 15 along the line of weakness, to expose the closure sealing element 24 so that the envelope 10 can be sealed closed. In such applications, the cover 44 can remain attached to the envelope 10 and inside of the envelope pocket 15 after the closure flap 42 has been folded into its closed position and the envelope 10 has been sealed closed.

The use of the cover 44 eliminates the need to place a release strip over the closure sealing element 24 to isolate the closure sealing element 24 from contact with other objects prior the loading and sealing of the envelope 10. Because the cover 44 is formed along with the wall 14, and from the same web 32a of paper material as the wall 14, the number and complexity of the production steps needed to form the envelope 10 are less than those of a production process for a comparable envelope in which a separate release strip needs to be placed over the closure sealing element of the envelope. Thus, the use of the cover 44 can facilitate higher production speeds and reduced scrap/downtime.

In alternative embodiments, one or both walls 12, 14 can include one or more functional layers positioned thereon. Examples of functional layers can include, but are not limited to, waterproofing layers (configured to reduce permeability of water therethrough), an airtight layer (configured to reduce permeability of air therethrough), other suitable material layers, and/or a combination thereof.

In other alternative embodiments, one or both walls 12, 14 can have a multi-ply configuration. For example, the walls 12, 14 each can be formed from two plies of relatively low basis-weight paper, such as two plies of 30 to 45-pound paper. The two plies of 30 to 45-pound paper can be used in lieu of a single ply of 90-pound paper. In some embodiments, padding, cushioning, or insulating material can be disposed between the plies of one or both multi-ply walls 12, 14. In other embodiments, the space between the plies can remain empty.

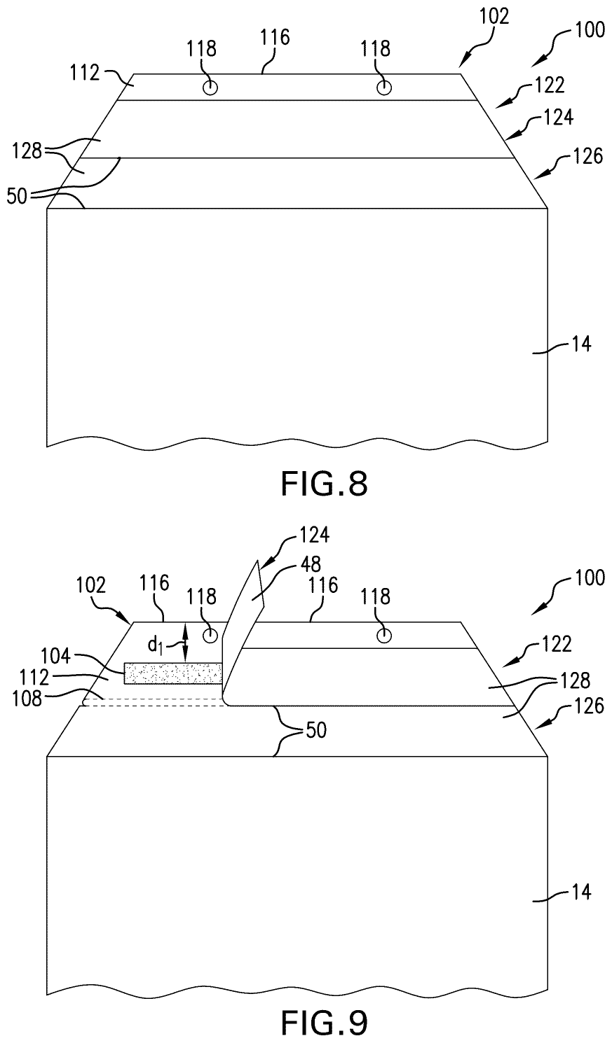

FIGS. 8 to 13 depict another alternative embodiment in the form of an envelope 100. The envelope 100 can be re-sealed and re-used after its initial use. This feature can be utilized, for example, to allow a customer to re-package an item initially sent to the customer in the envelope 100 and then ship the item to the original sender to facilitate a return of the item.

The envelope 100 is substantially identical to the envelope 10 with the following exceptions, and the above discussion of the envelope 10 applies equally to the envelope 100 unless otherwise noted. Components of the envelope 10 and the envelope 100 that are substantially identical are denoted by the same reference numbers.

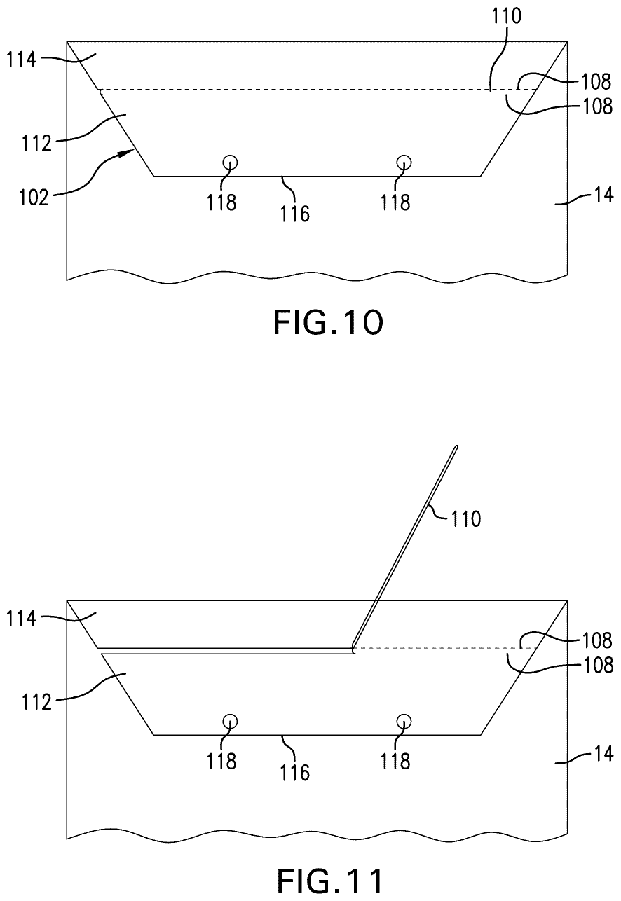

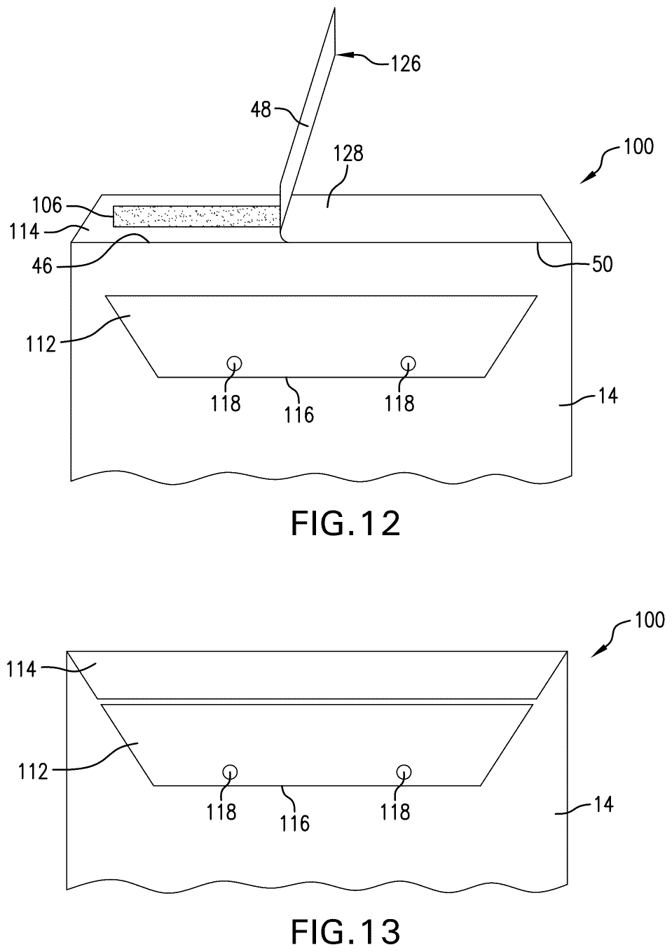

The envelope 100 includes a closure flap 102. The closure flap 102 is unitarily formed with the wall 12 and adjoins an upper edge of the wall 12. A score line 46, visible in FIG. 12, is formed at the interface of the closure flap 102 and the wall 12. The score line 46 causes the underlying portion of the envelope material to act as a living hinge that allows the closure flap 102 to rotate between an open position shown in FIGS. 8 and 9, and a closed position shown in FIGS. 10 and 11.

When in the open position, the closure flap 102 allows the envelope pocket 15 to be accessed via the opening 17 between the walls 12, 14, so that the packaged item 11 can be inserted into the envelope pocket 15 (the opening 17 is not depicted in FIGS. 8-13). When in the closed position, the closure flap 102 covers the opening 17 and thereby maintains the opening 17 in a closed state, so that the packaged item 11 is retained within the envelope 100.

The envelope 100 also includes a first bonding element in the form of first closure sealing element 104, and second bonding element in the form of a second closure sealing element 106. The first and second closure sealing elements 104, 106 are disposed on the closure flap 102, and are visible in FIGS. 9 and 12, respectively. The second closure sealing element 106 is disposed above the score line 46, from the perspective of FIG. 12, when the closure flap 102 is in its open position. The first closure sealing element 104 is disposed above the second closure sealing element 106, from the perspective of FIG. 9, when the closure flap 102 is in its open position. As discussed below, the first and second closure sealing elements 104, 106 are configured to bond to the outwardly facing surface of the wall 14 to fix the closure flap 42 in the closed position and maintain the opening 17 in its closed state. In alternative embodiments, the first and second closure sealing elements 104, 106 can be a continuous bonding element, i.e., the first and second closure sealing elements 104, 106 can adjoin each other.

The first and second closure sealing elements 104, 106 can be, for example, a pressure-sensitive hot-melt adhesive. Other types of bonding elements can be used as the first and second closure sealing elements 104, 106 in alternative embodiments. For example, the first and second closure sealing elements 104, 106 can be a pressure sensitive cold adhesive in alternative embodiments. In other alternative embodiments, for example, the first and second closure sealing elements 104, 106 can be a heat-seal material. In other alternative embodiments, for example, the first and second closure sealing elements 104, 106 can be a reactivatable hot-melt adhesive that is minimally tacky at room temperature. In some embodiments, the first and second closure sealing elements 104, 106 can be different types of bonding elements.

Two lines of perforations 108 are formed in the closure flap 102 between the first and second closure sealing elements 104, 106, as can be seen in FIGS. 9-11. The lines of perforations 108 define a tear strip 110 within the closure flap 102. The lines of perforations 108 form lines of weakness that permit the tear strip 110 to be removed from the remainder of the closure flap 102, as discussed below. The tear strip 110 divides the closure flap 102 into a first or upper portion 112 and a second or lower portion 114, with the first closure sealing element 104 being disposed on the first portion 112 and the second closure sealing element 106 being disposed on the second portion 114.

The upper edge of the first closure sealing element 104 is spaced from an upper edge 116 of the closure flap 102 by the distance d₁ denoted in FIG. 9. The distance d₁ can be, for example, about 0.5 inch. The distance d₁ can be greater or less than 0.5 inch in alternative embodiments. Two holes 118 are formed in the portion of the closure flap 102 located between the upper edge of the first closure sealing element 104 and the upper edge 116 of the closure flap 102. The holes 118 can receive the respective legs of a wicket (not shown) that permits a grouping, or flight of the envelopes 100 to be suspended the wicket. The wicket can be installed, for example, on a wall or backing board at or near a packing table, so that a packer can retrieve the envelopes 100 from the wicket on an individual basis as the envelopes 100 are needed to package items. The envelopes 100 can be retrieved from the wicket, for example, by pulling the envelope 100 downward so that the legs of the wicket rip the closure flap 102 between the holes 118 and the upper edge 116 of the closure flap. Alternative embodiments of the envelope 100 can be formed without the holes 118 or other provisions that facilitate installation of the envelopes on a wicket. In such embodiments, the closure flap 102 may be configured so that the upper edge of the first closure sealing element 104 is approximately coincident with the upper edge of 116 of the closure flap 102.

The envelope 10 also includes a cover 122, visible in FIGS. 8, 9, and 12. The cover 122 has a first or upper portion 124 and a second or lower portion 126. The cover 122 covers the closure flap 102 before the closure flap 102 is closed and sealed. More particularly, the first portion 124 of the cover 122 covers the first portion 112 of the closure flap 102, and the second portion 126 of the cover 122 covers the second portion 114 of the closure flap 102.

The cover 122 comprises a substrate 128 covered by the release layer 48 described above in relation to the envelope 10. The release layer 48 is configured to lightly adhere to the first and second closure sealing elements 104, 106 on the closure flap 102 so that the first and second portions 124, 126 of the cover 122 will be retained on the respective first and second portions 112, 116 of the closure flap 102 until the user removes the first and second portions 104, 106 from the respective first and second portions 112, 116.

Two kiss cuts 50 are formed in the web 32a from which the cover 122 and the wall 14 of the envelope 100 are formed, after the web 32a has been joined to the underlying web 32b, as discussed above in relation to the envelope 10. The kiss cuts 50 are visible in FIGS. 8, 9, and 12. One of the kiss cuts 50 is made at a location corresponding to the top of the wall 12 and the bottom of the second portion 126 of the cover 122. This location, as noted above in relation to the envelope 10, is approximately adjacent to the score line 46 formed at the interface of the wall 12 and the closure flap 102.

The second kiss cut 50 is formed at a location adjacent the tear strip 110 of the closure flap 102. The second kiss cut 50 divides the cover 122 into the first and second portions 124, 126 and permits the first portion 124 to be removed from the closure flap 102 independently of the second portion 126.

In alternative embodiments, the first or the second portion 124, 126 of the cover 122 can be formed from a conventional release strip placed on the first or second portions 112, 116 of the closure flap 102 during, or after formation of the envelope 10, instead of being formed from the web 32a.

The cover 122 has two of the holes 118 formed therein. The holes 118 in the cover 122 align with the holes 118 in the closure flap 102, and receive the legs of the wicket as discussed above in relation to the closure flap 102. In some applications, the envelopes 100 can be stacked into flights of multiple envelopes 100. A staple or other type of fastener can be inserted through the closure flaps 120 and covers 122 of the envelopes 100 within each flight to connect the envelopes 100. In alternative embodiments, stress relief features such as perforations, or U-shaped cuts having ends spaced from the upper edges of the closure flaps 120 and covers 122 by a small distance, e.g., ⅛ inch or less, can be formed in the closure flaps 120 and covers 122 around the fasteners, to reduce the potential for tearing of the closure flaps 120 as the envelopes 100 are separated from the flight during removal from the wicket.

As noted above, the envelope 100 can be re-sealed and re-used after its initial use. This feature can be used, for example, to allow a secondary user to re-package an item 11 initially sent to the secondary user in the envelope 100, and to ship the item 11 to the original sender to facilitate a return of the item 11.

When the envelope 100 is to be loaded and sealed initially, the initial user, e.g., a packer at a fulfillment center, can access and grasp the upper portion of the wall 14 by way of the kiss cut 50 between the wall 14 and the second portion 126 of the cover 122, with the closure flap 102 in its open position. The initial user then can pull the wall 14 away from the wall 12 to define the envelope pocket 15 and the opening 17 that leads thereto. The first and second portions 124, 126 of the cover 122 at this point remain attached to the respective first and second portions 112, 114 of the closure flap 102 as shown in FIG. 8, due to the adhesion of the release layer 48 on the cover 122 to the first and second closure sealing elements 104, 106 on the closure flap 102.

Once the opening 17 has been formed, the initial user can load the item 11 into the envelope pocket 15 by way of the opening 17. The initial user then can peel the first portion 124 of the cover 122 off the first portion 114 of the closure flap 102 to expose the first closure sealing element 104, as depicted in FIG. 9. The light adhesion of the release layer 48 on the first portion 124 of the cover 122 to the first closure sealing element 104 allows the first portion 124 to be removed without removing or otherwise damaging the first closure sealing element 104. Alternatively, the user can initiate the envelope loading process by first removing the first portion 124 of the cover 122 and then forming the opening 17 and loading the item 11 into the envelope pocket 15.

The initial user then can rotate the closure flap 102 about the score line 46, to its closed position. This brings the first closure sealing element 104 into contact with the outwardly facing surface of the wall 14, as shown in FIG. 10. The initial user then can press the first portion 112 of the closure flap 102 into the adjacent portion of the wall 14 so that the first closure sealing element 104 forms a closure seal that fixes the closure flap 102 to the wall 14, thereby securing the item 11 in the envelope pocket 15. The envelope 100 and item 11 are ready to be shipped or otherwise transported at this point. (In applications where the first closure sealing element 106 requires reactivation, the first closure sealing element 104 can be heated, and the first portion 112 of the closure flap 102 and the adjacent portion of the wall 14 can be pressed together to form the closure seal.)

Also at this point, the second portion 126 of the cover 122 remains attached to the second closure sealing element 106 on the cover 122, so that the second closure sealing element 106 is isolated from and does not adhere to the wall 14.

The item 11 can be removed from the envelope 100 be a subsequent or secondary user, e.g., a customer receiving the packaged item 11 shipped from the fulfillment center. The secondary user can open the envelope 100 by tearing the tear strip 110 from the remainder of the closure flap 102 as depicted in in FIG. 11. As discussed above, the lines of perforations 108 formed in the closure flap 102 facilitate separation of the tear strip 110 from the remainder of the closure flap 102.

Removal of the tear strip 110 separates the first portion 112 of the closure flap 102 from the second portion 114. As noted above, the second closure sealing element 106 on the second portion 114 of the closure flap 102 has remained covered by the second portion 126 of the cover 122 and thus has not adhered to the wall 14. Thus, once the tear strip 110 is removed from the cover 122, the second portion 114 of the closure flap 102 can be rotated to its open position as shown in FIG. 12, with the first portion 112 of the closure flap 102 remaining attached to the wall 14 by the closure seal previously formed by the first closure sealing element 104.

Once the second portion 114 of the closure flap 102 has been rotated to its open position, the secondary user can access and grasp the upper portion of the wall 14 by way of the kiss cut 50 between the wall 14 and the second portion 126 of the cover 122. The customer then can pull the wall 14 away from the wall 12, to define the envelope pocket 15 and the opening 17 that leads thereto. Once the opening 17 has been formed, the secondary user can load the item 11 into the envelope pocket 15 by way of the opening 17.

The secondary user then can peel the second portion 126 of the cover 122 off the second portion 116 of the closure flap 102 to expose the second closure sealing element 106 on the closure flap 102, as depicted in FIG. 12. The light adhesion of the release layer 48 on the second portion 126 of the cover 122 and the second closure sealing element 106 allows the second portion 126 to be removed without removing or otherwise damaging the second closure sealing element 106. Alternatively, the secondary user can initiate the envelope re-loading process by first removing the second portion 126 of the cover 122 and then forming the opening 17 and loading the item 11 into the envelope pocket 15.

The user then can rotate the second portion 116 of the closure flap 102 about the score line 46, to its closed position, bringing the second closure sealing element 106 into contact with the outwardly facing surface of the wall 14 as shown in FIG. 13. The user can press the second portion 116 of the closure flap 102 into the adjacent portion of the wall 14 so that the second closure sealing element 106 forms a closure seal that fixes the second portion 116 to the wall 14, thereby securing the item 11 in the envelope pocket 15. (In applications where the second closure sealing element 106 requires reactivation, the second closure sealing element 106 can be heated, and the second portion 114 of the closure flap 112 and the adjacent portion of the wall 14 can be pressed together to form the closure seal.) At this point, the re-loaded and re-sealed envelope is ready to be shipped or otherwise transported.

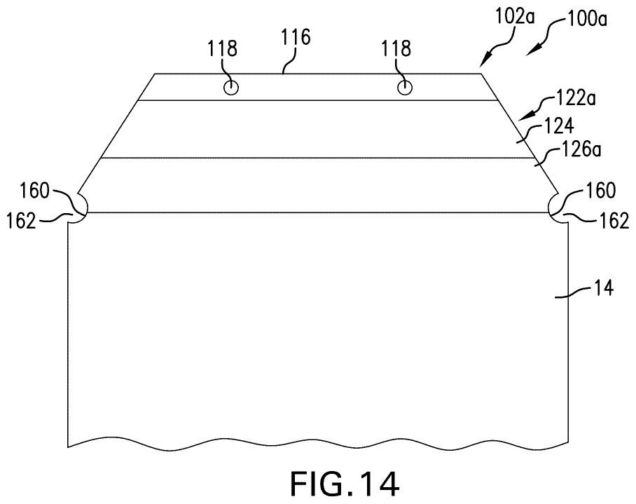

FIG. 14 depicts an alternative embodiment of the envelope 100 in the form of an envelope 100a. The envelope 100a is identical to the envelope 100, with the following exception. The envelope 100a includes a closure flap 102a and a cover 122a in which C-shaped cuts 160 are formed in the second portion of the closure flap 102a, the second portion 126a of the cover 122a, the walls 12, 14, and the gussets 33. The cuts 160 extend through the score line about which the closure flap 102a rotates. Each C-shaped cut 160 defines cutouts 162 at the upper corners of a corresponding gusset 33. The cutouts 162 provide stress relief for the gussets and the adjoining walls 12, 14 when the envelope 100a is opened, i.e., when the wall 14 is pulled away from the wall 12 to form the opening 17. Stress-relief cutouts similar or identical to the cutouts 162 can be formed in alternative embodiments the envelope 10.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above-described embodiments. Rather, the scope of the present solution should be defined in accordance with the following claims and their equivalents.

What is claimed is:

1. An envelope for holding an item, comprising:
a first wall;
a second wall overlying the first wall, the first and second walls defining:
a pocket located between the first and second walls, the pocket configured and dimensioned to contain the item, and
a pocket opening allowing access to the pocket from an exterior of the envelope for loading the item into the pocket;
a closure flap hingedly connected to the first wall to rotate between:
an open position, allowing access to the pocket through the pocket opening, and
a closed position in which the closure flap extends from the first wall, across the pocket opening on onto the second wall to attach thereto, thereby closing the pocket opening;
a bonding element disposed on the closure flap and configured to seal to the second wall when the closure flap is in the closed position; and
a cover overlying the bonding element, wherein the cover comprises a substrate formed from the same material as the second wall, and a release layer disposed on the substrate, the release layer configured to bond sufficiently to the bonding element so that the cover is releasably attached to the closure flap.

2. The envelope of claim 1, wherein the release layer extends to an upper edge of the substrate.

3. The envelope of claim 1, wherein the release layer covers an entirety of one side of the substrate.

4. The envelope of claim 1, wherein a perimeter of the cover matches a perimeter of the closure flap.

5. The envelope of claim 1, further comprising a separation region between the cover and the second wall.

6. The envelope of claim 5, wherein the separation region includes a cut separating the cover from the second wall.

7. The envelope of claim 6, wherein the cut is a kiss cut.

8. The envelope of claim 5, wherein the separation region includes a line of weakness sufficient to propagate a tear along the line of weakness.

9. The envelope of claim 8, wherein the line of weakness includes perforations and/or a score line.

10. The envelope of claim 1, wherein the bonding element has sufficient tackiness to adhere to the release layer to retain the cover on the closure flap.

11. The envelope of claim 10, wherein the bonding element is a hot-melt adhesive.

12. The envelope of claim 1, wherein the closure flap is further configured to close the pocket opening.

13. The envelope of claim 1, wherein the bonding element is configured to form the closure seal upon application of pressure to the bonding element.

14. The envelope of claim 1, wherein the first wall and/or second wall is made of paper.

15. The envelope of claim 1, further comprising a gusset connected to the first and second walls.

16. The envelope of claim 15, further comprising an attachment lip extending from the gusset and fixed to an exterior side of the envelope.

17. The envelope of claim 1, wherein:
the closure flap includes side edges tapered in relation to a longitudinal direction of the envelope; and
the cover includes side edges having a taper that approximately matches a taper of the side edges of the closure flap.

18. The envelope of claim 1, wherein the second wall and the substrate are cut from a single piece of web material.

19. The envelope of claim 1, wherein the cover comprises:
a first portion configured to overlie a first portion of the bonding element when the closure flap is in the first position; and
a second portion configured to overlie a second portion of the bonding element when the closure flap is in the first position, the second portion of the cover configured to be removed from the second portion of the bonding element while the first portion of the cover overlies the first portion of the bonding element.

20. The envelope of claim 1, wherein the first and second walls are flexible.

21. The envelope of claim 1, wherein the first wall and/or the second wall comprise at least two overlying layers affixed to each other about an interlayer border that encloses a plurality of sides of an interlayer region defined by the at least two overlying layers.

22. A method of manufacturing an envelope, comprising:
providing a first web of material and a second web of material;
applying a first bonding element on the first and/or the second web;
applying a release layer on the second web;
applying a second bonding element on the first and/or the second web;
overlaying the second web on the first web;
joining the first web to the second web; and
creating a separation region through the second web adjacent to the release layer to define a cover comprising the release layer and an overlying portion of the second web, the separation region allowing the cover to be peeled off and separated from second wall.

23. The method of claim 22, wherein joining the first web to the second web comprises bringing the first web into contact with the second web so that the first bonding element forms side and transverse seals between the first and second webs, and the second bonding element opposes the release layer.

24. The method of claim 23, further comprising applying heat or pressure to form the side and transverse seals between the first and second webs.

25. The method of claim 22, wherein creating a separation region through the second wall adjacent to the release layer comprises forming at least one or more of a kiss cut and lines of weakness in the second web.

26. The method of claim 22, further comprising removably adhering the cover to the first wall via the second bonding element and the release layer.

27. The method of claim 26, wherein the release layer configured to bond sufficiently to the bonding element so that the cover is releasably attached to the closure flap.

28. The method of claim 22. further comprising forming a fold line in the first web adjacent the separation region.

29. The method of claim 22, wherein the second bonding element is pressure-sensitive adhesive.

30. The method of claim 22. wherein the first web and/or the second web is made of paper.
